(19) United States
(12) Patent Application Publication
(10) Pub. No.: US 2007/0212553 A1
(43) Pub. Date: Sep. 13, 2007

(54) PUNCTURE RESISTANT COMPOSITE

(76) Inventor: ROBERT B. STEARNS, Luna Pier, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/276,708

(22) Filed: Mar. 10, 2006

(51) Int. Cl. B32B 27/40; B32B 27/00

(52) U.S. Cl. 428/423.1; 264/255

(57) ABSTRACT

A puncture resistant composite article includes a first layer having a specific gravity of from 0.9 to 1.15 g/ml and formed from an elastomeric urethane composition including the cured reaction product of an isocyanate component and a resin composition including polytetrahydrofuran. The composite article also includes a second layer disposed on the first layer. A method of forming the composite article includes the step of spraying the isocyanate component and the particular resin composition into a mold cavity in a conical spray pattern or a substantially planar spray pattern. The method also includes the steps of reacting the isocyanate component and the resin composition to form the elastomeric urethane composition, curing the elastomeric urethane composition to form the first layer, applying a urethane composition into the mold cavity, curing the urethane composition to form the second layer and the composite article, and de-molding the composite article.

### FIELD OF THE INVENTION

The present invention generally relates to a composite article and a method of forming the composite article. More specifically, the method includes the step of reacting an isocyanate component and a resin composition including polytetrahydrofuran to form an elastomeric urethane composition.

### DESCRIPTION OF THE RELATED ART

Composite articles that include multiple layers are well known in the art. Specifically, composite articles that include a layer formed from an elastomeric urethane composition are known to be used in both automotive and non-automotive supplies. The composite articles that include the layer formed from the elastomeric urethane composition are typically formed by applying the elastomeric urethane composition into a mold. The elastomeric urethane composition is then cured to form the layer of the composite article.

Over time, needs have arisen for the composite articles to have increased tensile strength, elongation, Graves tear strength, Taber abrasion resistance, Shore A Durometer Hardness, and puncture resistance (i.e., resistance to environmental stresses including perforating and puncturing.) In response to these needs, manufacturers have included exterior layers formed from the elastomeric urethane compositions on the composite articles. However, in many applications, these composite articles have exhibited inconsistent and insufficient puncture resistance. As a result, the manufacturers have increased the thicknesses of the exterior layers, which has decreased production speed and efficiency and has increased chemical usage and production costs.

The inconsistent and insufficient puncture resistance associated with the composite articles having the exterior layers formed from the elastomeric urethane compositions is due, in part, to the methods used to apply the elastomeric urethane compositions. Typically, the methods of applying the elastomeric urethane compositions include spraying, wherein elastomeric urethane compositions are sprayed into the mold cavities and cured. The act of spraying introduces air bubbles into the elastomeric urethane compositions and the resulting layers and decreases the specific gravities of the layers formed from the elastomeric urethane compositions. The specific gravities of the layers are decreased as compared to the specific gravities of totally homogeneous layers without air bubbles. It is believed that decreases in the specific gravities contribute to decreases in the puncture resistance of the composite articles.

Accordingly, there remains an opportunity to form a composite article having increased puncture resistance. There also remains an opportunity to form the composite article having the increased puncture resistance, with increased speed and production efficiency and with reduced chemical usage resulting in reduced production costs.

### SUMMARY OF THE INVENTION AND ADVANTAGES

The present invention provides a method of forming a composite article in a mold having a mold cavity. In a first embodiment of the present invention, the method includes the step of applying an isocyanate component and a resin composition including polytetrahydrofuran into the mold cavity. The method also includes the step of reacting the isocyanate component and the resin composition to form an elastomeric urethane composition. The method further includes the step of curing the elastomeric urethane composition to form a first layer having a specific gravity of from 0.9 to 1.15 g/ml.

In a second embodiment of the present invention, the method includes the step of spraying the isocyanate component and the resin composition including the polytetrahydrofuran into the mold cavity in one of a conical spray pattern or a substantially planar spray pattern. The method also includes the step of reacting the isocyanate component and the resin composition to form the elastomeric urethane composition. The method further includes the step of curing the elastomeric urethane composition to form the first layer.

In both the first and second embodiments, the method includes the step of applying a urethane composition different from the elastomeric urethane composition into the mold cavity. In these embodiments, the method also includes the step of curing the urethane composition in the mold cavity to form a second layer and to form the composite article and the step of de-molding the composite article from the mold cavity.

As such, the method of forming the composite article is established. The method eliminates a need to continually increase thicknesses of the first layer to increase puncture resistance and allows the composite article to be formed with increased speed and production efficiency and with less chemical usage resulting in reduced production costs.

The present invention also provides a composite article including the first layer having a specific gravity of from 0.9 to 1.15 g/ml and including a cured reaction product of the isocyanate component and the resin composition including the polytetrahydrofuran. The composite article also includes the second layer disposed on the first layer and formed from the cured urethane composition that is different from the cured reaction product.

The specific gravity of the first layer of 0.9 to 1.15 g/ml results from a minimization of air bubbles in the first layer corresponding with an increased homogeneity of the first layer. Decreasing the amount of air bubbles in the first layer and thereby increasing the specific gravity of the first layer increases puncture resistance of the composite article.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

FIG. 1 is a cross-sectional side view of a first embodiment of a composite article of the present invention;

FIG. 2 is a cross-sectional side view of a second embodiment of a composite article of the present invention;

FIG. 3 is a perspective view of a mold having a mold cavity and a spray gun having a cone nozzle spraying at least one of an isocyanate component and a resin composition in a conical spray pattern; and

FIG. 4 is a perspective view of a mold having a mold cavity and a spray gun having a fan nozzle spraying at least one of an isocyanate component and a resin composition in a substantially planar spray pattern.

### DETAILED DESCRIPTION OF A PREFERRED EMBODIMENT

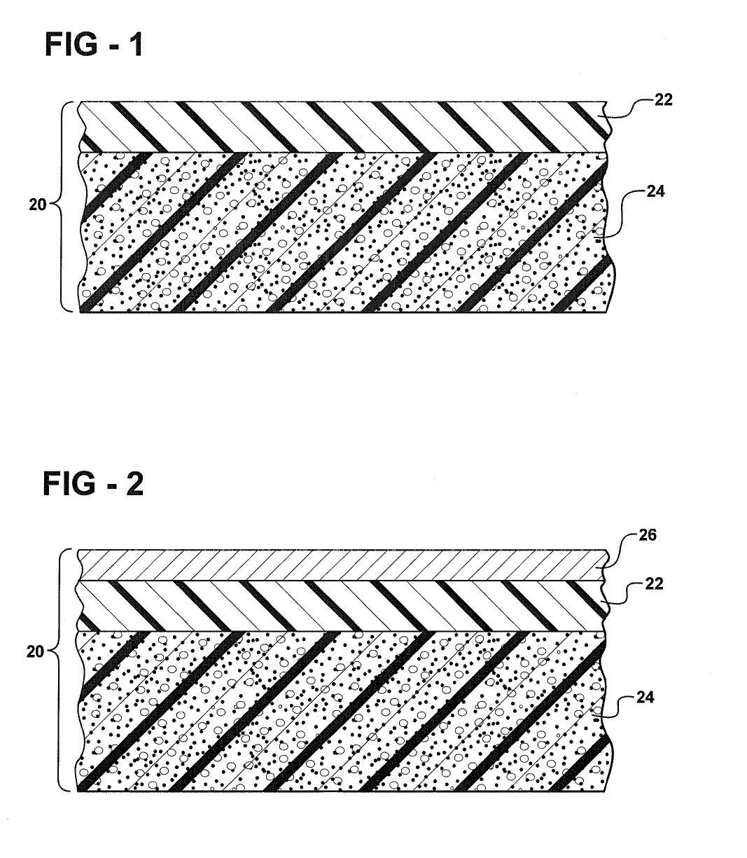

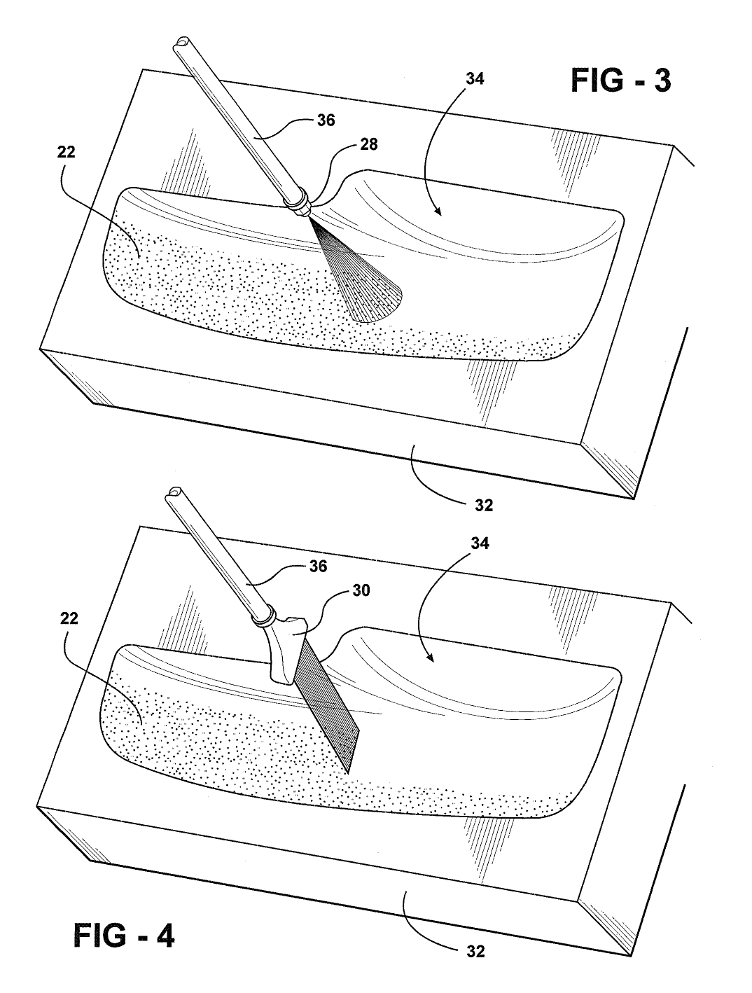

Referring to FIGS. 1 through 4, the present invention provides a method of forming a composite article (20) in a mold (32) having a mold cavity (34). It is contemplated that the mold (32) may be an open mold or may be a closed mold. As shown in FIGS. 3 and 4, the mold (32) is an open mold. In a first embodiment of the present invention, the method includes the step of applying an isocyanate component and a resin composition including polytetrahydrofliran into the mold cavity (34). The method also includes the step of reacting the isocyanate component and the resin composition to form an elastomeric urethane composition. The method further includes the step of curing the elastomeric urethane composition to form a first layer (22) having a specific gravity of from 0.9 to 1.15 g/ml. Although not necessarily required, in the first embodiment, the isocyanate component and the resin composition are preferably sprayed into the mold cavity (34) in one of a conical spray pattern or a planar spray pattern.

In a second embodiment of the present invention, the method includes the step of spraying the isocyanate component and the resin composition including the polytetrahydrofuran into the mold cavity (34) in one of the conical spray pattern or the substantially planar spray pattern. The method also includes the step of reacting the isocyanate component and the resin composition to form the elastomeric urethane composition. The method further includes the step of curing the elastomeric urethane composition to form the first layer (22).

In both the first and second embodiments, the method includes the step of applying a urethane composition different from the elastomeric urethane composition into the mold cavity (34). In these embodiments, the method also includes the step of curing the urethane composition in the mold cavity (34) to form a second layer (24) and to form the composite article (20) and the step of de-molding the composite article (20) from the mold cavity (34).

However, before the aforementioned steps are performed, it is contemplated that the mold cavity (34) may be coated with a known mold release agent to facilitate an eventual de-molding of the composite article (20). The mold release agent may be applied to the mold cavity (34) by any method known in the art including, but not limited to, manual and/or automatic spraying, pouring, placing, and combinations thereof. If utilized, the mold release agent may include, but is not limited to, silicones, soaps, waxes, solvents, and combinations thereof.

Alternatively, or in addition to application of the mold release agent, a coating composition (26) having a predetermined color may be sprayed or poured into the mold cavity (34). The coating composition (26) may be selected from a variety of water and solvent borne solutions. The coating composition (26) may also include a one or multi-component composition. Among the numerous available coating compositions (26) which are suitable for use in the present invention, the most preferred coating compositions (26) for use in the present invention include Protothane®, commercially available from Titan Finishes Corporation of Detroit, Mich., Polane®, commercially available from Sherwin Williams, Inc. of Cleveland, Ohio, and Rimbond®, commercially available from Lilly Corporation of Aurora, Ill. The coating composition (26) may be manually and/or automatically sprayed or poured into the mold cavity (34) in any amount depending on desired characteristics of the composite article (20), as determined by one skilled in the art.

Preferably, after applying the mold release agent and prior to spraying the isocyanate component and the resin composition into the mold cavity (34), the isocyanate component and resin composition are mixed by impingement mixing in a head of a spray gun (36). Impingement mixing includes mixing streams of the isocyanate component and the resin composition under pressure in the head of the spray gun (36). The isocyanate component and the resin composition may be mixed at any temperature and at any pressure in the head of the spray gun (36). Preferably, the isocyanate component and the resin composition are mixed at a temperature of greater than 100° F. and more preferably at a temperature of approximately 150° F., and at a pressure of greater than 1,000 psi and more preferably at a pressure of approximately 1,500 psi.

Referring now to the step of applying the isocyanate component and the resin composition into the mold cavity (34), the isocyanate component and the resin composition may be applied over the mold release agent and/or coating composition (26) if present and, in the absence thereof, directly into the mold cavity (34). In the first embodiment, the isocyanate component and the resin composition may be applied into the mold cavity (34) by any method known in the art, including, but not limited to, spraying, pouring, and combinations thereof. Preferably, in the first embodiment, the step of applying the isocyanate component and the resin composition includes the step of spraying at least one of the isocyanate component and the resin composition.

In the first embodiment, if at least one of the isocyanate component and the resin composition is sprayed, the step of spraying preferably includes the step of spraying at least one of the isocyanate component and the resin composition into the mold cavity (34) in one of the conical spray pattern or the substantially planar spray pattern, as first introduced above. However, it is contemplated that both the isocyanate component and the resin composition may be sprayed in one of the conical spray pattern or the substantially planar spray pattern.

In the second embodiment, the isocyanate component and the resin composition are sprayed. More specifically, the second embodiment includes the step of spraying the isocyanate component and the resin composition in one of the conical spray pattern or the substantially planar spray pattern. It is to be understood that the terminology “substantially planar spray pattern” includes a spray pattern that is planar, nearly planar and/or exhibiting characteristics associated with a planar element, without necessarily being restricted to this meaning. Preferably, the step of spraying in one of the conical spray pattern or the planar spray pattern includes the step of spraying with one of a cone nozzle (28) or a fan nozzle (30) of the spray gun (36), respectively. It is contemplated that any cone nozzle (28) or fan nozzle (30) known in the art may be used in the present invention. Particularly suitable cone nozzles (28) include, but are not limited to, full cone nozzles, hollow cone nozzles, and combinations thereof. Particularly suitable fan nozzles (30) include, but are not limited to, flat fan nozzles, flooding fan nozzles, and combinations thereof. Without intending to be limited by any particular theory, it is believed that spraying in one of the conical spray pattern or the substantially planar spray pattern increases a specific gravity of the elastomeric urethane composition, i.e., minimizes an amount of air entrapped in the elastomeric urethane composition, thus resulting in greater puncture resistance of the composite article (20). The specific gravity will be described in greater detail below.

If the method includes the step of spraying, spray processing parameters may be manipulated. The spray processing parameters that are typically manipulated include, but are not limited to, a temperature and pressure of the isocyanate component and/or the resin composition entering the spray gun (36) and a throughput of the spray gun (36). The temperature is preferably maintained between 25 and 85, and more preferably between 55 and 74° C. Similarly, if the pressure of the isocyanate component and/or the resin composition entering the spray gun (36) is manipulated, the pressure is preferably maintained between 700 and 1500, and more preferably between 900 and 1100, psi. Also, if the throughput of the spray gun (36) is manipulated, the throughput is preferably maintained between 5 and 50, and most preferably between 17 and 40, g/sec. Preferably, each of the aforementioned spray processing parameters may be optimized for use when either the isocyanate component and/or the resin composition has a viscosity of up to 20,000, and more preferably of from 200 to 4,000, cps at 25° C.

During application of the isocyanate component and the resin composition into the mold cavity (34), it is understood by those skilled in the art that the amount of water and humidity present in the mold cavity (34) is an important condition to be considered when making the composite article (20). Preferably, the amount of water and humidity is minimized to reduce any possible foaming of the elastomeric urethane composition. However, some water and humidity may be present without adversely affecting the isocyanate component and the resin composition. Typically, the isocyanate component and the resin composition are applied into the mold cavity (34) in the presence of less than 100, more typically of less than 17, even more typically of less than 14, and most typically of less than 7, grains/pound absolute humidity.

The isocyanate component that is applied into the mold cavity (34) preferably includes an aromatic isocyanate. If the isocyanate component includes an aromatic isocyanate, the aromatic isocyanate preferably corresponds to the formula R′(NCO)_{z} wherein R′ is a polyvalent organic radical which is aromatic and z is an integer that corresponds to the valence of R′. Preferably, z is at least two. The isocyanate component of the present invention preferably includes the aromatic isocyanate because the aromaticity imparts increased reactivity towards the reaction of the isocyanate component and the resin composition, specifically, the polytetrahydrofuran. The aromaticity also reduces costs associated with manufacture of the isocyanate component. Most preferably, the isocyanate component includes a 4,4′-methylenediphenyl diisocyanate. Preferred examples of 4,4′-diphenylmethane diisocyanates are commercially available from BASF Corporation of Wyandotte, Mich., under the trade names of Lupranate® MM103, Lupranate® M, Lupranate® MP102, Lupranate® LP30, and Lupranate® LP30D.

Other aromatic isocyanates that may be used include, but are not limited to, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisochyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, polymethylene polyphenylene polyisocyanate, corresponding isomeric mixtures thereof, and combinations thereof.

If the isocyanate component includes the aromatic isocyanate, the isocyanate component may also include a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The isocyanate component may also include, but is not limited to, modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. The isocyanate component may also include stoichiometric or non-stoichiometric reaction products of the aforementioned isocyanates. However, the isocyanate component may alternatively include an aliphatic isocyanate, and/or combinations of the aromatic isocyanate and the aliphatic isocyanate. It is contemplated that in all embodiments of the present invention, any isocyanate known in the art may be used in the present invention as the isocyanate component.

The isocyanate component preferably has a % NCO content of from 8 to 34, more preferably of from 10 to 30, and most preferably of from 20 to 30, percent by weight. Determination of the % NCO content on percent by weight is accomplished by a standard chemical titration analysis known to those skilled in the art. Also, the isocyanate component preferably has a nominal functionality of from 1.7 to 3, more preferably of from 1.9 to 3, and most preferably of from 1.9 to 2.1. Further, the isocyanate component preferably has a number average molecular weight of from 125 to 525, more preferably of from 140 to 420, and most preferably of from 183 to 420, g/mol. Still further, the isocyanate component preferably has a viscosity of from 15 to 2000, more preferably of from 50 to 1000, and most preferably of from 50 to 700, cps at 25° C.

Referring now to the resin composition applied into the mold cavity (34), the resin composition includes polytetrahydrofuran. Preferably, the resin composition includes at least 60 parts by weight of the polytetrahydrofuran per 100 parts by weight of the resin composition. More preferably the resin compositions includes at least 80, and most preferably at least 85, parts by weight of the polytetrahydrofuran per 100 parts by weight of the resin composition. The resin composition may be substantially free of other polyols other than polytetrahydrofuran. It is to be understood that substantially free, as related to the present invention, preferably includes an amount of other polyols in the resin composition of less than 1, more preferably of less than 0.50, and most preferably of less than 0.05, parts by weight per 100 parts by weight of the resin composition. It is contemplated that the resin composition may consist essentially of polytetrahydrofuran. In all embodiments, any polytetrahydrofuran may be utilized. Preferably, the polytetrahydrofuran includes polytetrahydrofuran commercially available from BASF Corporation of Wyandotte, Mich., under the trade name of PolyTHF®. Particularly suitable polytetrahydrofurans include, but are not limited to, PolyTHF® 250, PolyTHF′ 650, PolyTHF® 650 S, PolyTHF® 1000, PolyTHF® 1000 S, PolyTHF® 1400, PolyTHF® 1800, PolyTHF′ 2000, and combinations thereof.

The resin composition may also include one or more polymerization catalysts. If so, the polymerization catalyst may include an amine. If the polymerization catalyst includes an amine, the amine typically includes, but is not limited to, triethylenediamine, N-methylmorpholine, N-ethylmorpholine, diethylethanolamine, N-cocomorpholine, 1-methyl-4-dimethylaminoethylpiperizine, 3-methoxypropyldimethylamine, N,N,N′-trimethylisopropyl propylenediamine, 3-diethylaminopropyldiethylamine, dimethylbenzylamine, ethylhexanoic acid blocked 1,8-Diazabicyclo[5.4.0]undec-7-ene, and combinations thereof. Most preferably, the polymerization catalyst includes two amines commercially available from Air Products and Chemicals, Inc. of Allentown, Pa., under the trade names of DABCO® S-25 and Polycat® SA-102, respectively. The DABCO® S-25 includes triethylenediamine and 1,4 butanediol. The Polycat® SA-102 includes ethylhexanoic acid blocked 1,8-Diazabicyclo[5.4.0]undec-7-ene.

The polymerization catalyst may also include a metal including, but not limited to, bismuth, potassium, lead, tin, zinc, mercury, titanium, zirconium, hafnium, and combinations thereof. Particularly suitable examples of the polymerization catalyst include, but are not limited to, stannous chloride, dibutyltin di-2-ethyl hexanoate, stannous oxide, dioctyltin dimercaptin, bismuth carboxylate, zinc carboxylate, and combinations thereof.

The polymerization catalyst may be present in the resin composition in any amount. Preferably, the polymerization catalyst is present in the resin composition in an amount of less than or equal to 6, more preferably of from 0.02 to 1.5, and most preferably of from 0.02 to 0.5, parts by weight per 100 parts by weight of the resin composition.

Preferably, the polymerization catalyst does not effectively catalyze an undesirable side reaction of water and humidity with the isocyanate component. Reaction of water and humidity with the isocyanate component forms gaseous carbon dioxide and foams the elastomeric urethane composition, as is well known in the art. Foaming the elastomeric urethane composition with the gaseous carbon dioxide is undesirable and forms voids and blisters. It is believed that formation of voids and blisters results in a degradation of physical properties of the elastomeric urethane composition including a weakened structural stability, a decreased and non-homogeneous density, and a reduced puncture resistance. As such, it is to be understood that the elastomeric urethane composition of the present invention is not foamed. Any foaming that occurs is not desired, is preferably minimized and is most preferably eliminated.

The resin composition may further include one or more additives selected from the group of chain extenders, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, thixotropic agents, and combinations thereof. The one or more additives may be included in any amount.

The resin composition may include a chain extender as an additive. Examples of preferred chain extenders include compounds having at least two functional groups with active hydrogen atoms including, but not limited to, hydrazine, primary and secondary diamines, alcohols, amino acids, hydroxy acids, glycols, and combinations thereof. Such chain extenders typically have a number average molecular weight of less than about 400 g/mol. However, chain extenders with number average molecular weights of greater than 400 g/mol are also contemplated for use. More preferably, the chain extender is selected from the group of ethylene glycol, 1,4-butanediol, 1,3-butanediol, propylene glycol, dipropylene glycol, diethylene glycol, glycerine and combinations thereof. Most preferably, the chain extender is selected from the group of 1,4-butanediol, 1,3-butanediol, and combinations thereof. 1,4-butanediol is commercially available from BASF Corporation of Wyandotte, Mich. 1,3-butanediol is commercially available from GE Silicones of Wilton, Conn., under the trade name of NIAX® Processing Additive DP-1022.

Chain extenders typically act as cross-linking agents and improve physical characteristics of the elastomeric urethane composition. While an amount of chain extender included in the resin composition is, in large part determined by an anticipated end use of the elastomeric urethane composition, the resin composition preferably includes of from 1 to 20, more preferably of from 6 to about 15, and most preferably of from 8 to about 10, parts by weight of the chain extender per 100 parts by weight of the resin composition.

The resin composition may also include the anti-foaming agent as an additive. If included, the anti-foaming agent preferably includes a silicone liquid commercially available from Dow Coming of Midland, Mich., under the trade name of Antifoam-A. The anti-foaming agent typically acts to reduce the amount of gaseous carbon dioxide formed from the reaction of water and humidity and the isocyanate component. If included in the resin composition, the anti-foaming agent is preferably included in an amount of from 0.01 to 0.50 and most preferably of from 0.05 to 0.15, parts by weight of the anti-foaming agent per 100 parts by weight of the resin composition.

The resin composition may also include the chain terminator as an additive. If included, the chain terminator preferably is an alcohol. More preferably, the chain terminator includes a primary alcohol. Most preferably, the chain terminator includes a blend of C₁₂, C₁₃, C₁₄ and C₁₅ high purity primary alcohols commercially available from Shell Chemical LP of Houston, Tex., under the trade name of Neodol® 25. If included in the resin composition, the chain terminator is preferably included in an amount of from 1 to 6, more preferably of from 2 to 4, and most preferably 3, parts by weight of the chain terminator per 100 parts by weight of the resin composition.

The resin composition may also include the water scavenger as an additive. The water scavenger preferably includes a molecular sieve. Most preferably, the molecular sieve is commercially available from UOP, LLC, of Des Plaines, Ill., under the trade name of Molecular Sieve Type 3A. If included in the resin composition, the water scavenger is preferably included in an amount of from 0.1 to 2, more preferably of from 0.5 to 1.5, and most preferably of from 0.8 to 1.2, parts by weight per 100 parts by weight of the resin composition.

The resin composition may also include the fumed silica as the additive. The fumed silica preferably acts as a suspending agent for the water scavenger. The fumed silica is commercially available from Degussa AG of Düsseldorf, Germany, under the trade name of Aerosil® R972. If included in the resin composition, the fumed silica is preferably included in an amount of from 0.2 to 1.5 parts by weight per 100 parts by weight of the resin composition.

Although less preferred, the resin composition may also include a polyol different from the polytetrahydrofuran. The polyol different from the polytetrahydrofuran may be included in the resin composition as a diluent to dissolve the polytetrahydrofuran. As is known in the art, polytetrahydrofuran may be solid at room temperature. If the polyol is included, the polyol may be any polyol known in the art. The polyol may include graft polyols and may include polyether polyols, polyester polyols, polycarbonate polyols, and combinations thereof.

Referring now to the step of reacting the isocyanate component and the resin composition, the isocyanate component and the resin composition may be reacted at any temperature and at any pressure to form the elastomeric urethane composition, as selected by one skilled in the art. Although the isocyanate component and the resin composition spontaneously react, reaction may be delayed and non-ideal. As such, the isocyanate component and the resin composition are preferably reacted at a temperature of greater than 100° F. and more preferably at a temperature of approximately 150° F., and at a pressure of approximately 760 torr. The isocyanate component and the resin composition may also be reacted at any isocyanate index, as determined by one skilled in the art. Preferably, the step of reacting the isocyanate component and the resin composition includes the step of reacting the isocyanate component and the resin composition at an isocyanate index of from 90 to 115, more preferably of from 95 to 105, and most preferably of from 98 to 102. It is to be understood that the isocyanate component and the resin composition may begin reacting in the head of the spray gun (36) and may continue to react while being applied and/or sprayed and after. It is contemplated that the isocyanate component and the resin composition may not begin to react until mixed.

Referring now to the step of curing the elastomeric urethane composition to form the first layer (22), the first layer (22) may be cured at any temperature and for any time. Preferably, the step of curing the elastomeric urethane composition to form the first layer (22) includes the step of curing at a temperature of at least 60, more preferably of from 60 to 80, and most preferably from 65 to 75,° F. The first layer (22), after curing, may have any thickness. Preferably, the first layer (22) has a thickness of from 0.025 to 0.2, more preferably of from 0.025 to 0.15, and most preferably of approximately 0.05, inches. It is to be understood that the first layer (22) does not have to be the outermost layer of the composite article (20) and may be an interior layer of the composite article (20). However, the first layer (22) may be the outermost layer of the composite article (20) and preferably is a show surface of the composite article (20).

The specific gravity of the first layer (22) is believed to contribute to the puncture resistance of the composite article (20), as first introduced above. The specific gravity, as referred to herein, is defined as a ratio of the density of the first layer (22) to the density of water at 25° C. The specific gravity of the first layer (22) is from 0.9 to 1.15, preferably of from 0.98 to 1.15, more preferably of from 1.05 to 1.15, even more preferably of from 1.10 to 1.15, and most preferably of approximately 1.15, g/ml. However, the first layer (22) may have any specific gravity between 0.9 and 1.15 g/ml.

Also, the first layer (22), after curing, preferably has a puncture resistance of greater than 250, more preferably of greater than 400, still more preferably of greater than 500, and most preferably of greater than 600, pounds per inch, as determined using a puncture resistance test method. The puncture resistance test method is used to determine the puncture resistance of a sample of the first layer (22) by measuring a force required to cause a 0.1 inch diameter tip of a sharp-edged puncture probe to penetrate the sample. Specifically, a sample is cut such that the sample has a diameter of 1.2 inches. The sample is fitted around an orifice of a support instrument and an edge of the sample is crimped around the orifice to hold the sample in place. The puncture probe is operated at a speed of 2 inches per minute and punctures the sample. The force required to puncture the sample is divided by a thickness of the sample and reported as the puncture resistance.

Additionally, the first layer (22) also preferably has a Shore A Durometer Hardness of from 50 to 100, and more preferably of from 50 to 75, as determined by ASTM D-2240. The Shore A Durometer Hardness is a measure of a resistance of the first layer (22) towards indentation.

Referring now to the step of applying the urethane composition different from the elastomeric urethane composition in the mold cavity (34), the urethane composition preferably includes a foamed urethane composition. The urethane composition can be modified in density, crush resistance and other important characteristics and may be foamed using any physical and/or chemical blowing agent known in the art. As such, the density of the urethane composition can be controlled independently of the density of the elastomeric urethane composition.

The composite article (20) may also include additional layers. If additional layers are included in the article, the additional layers are preferably the same as the second layer (24), described above and preferably including a cured reaction product of the isocyanate component and the resin composition. However, additional layers that are different from the second layer (24) and different from the first layer (22) are also contemplated for use in the present invention. If additional layers are included, the additional layers may be disposed on either the first and/or the second layer (24), and may be disposed in contact with the first and/or the second layer (24) or may be separated from the first and/or the second layer (24).

Preferably, the second layer (24) serves as the support layer to the first layer (22). As such, the urethane composition may be applied to the first layer (22) directly, i.e., in contact with the first layer (22). The urethane composition is preferably applied into the mold cavity (34) after the isocyanate component and the resin composition are applied or sprayed into the mold cavity (34) and preferably after the first layer (22) is cured. However, the urethane composition may be applied into the mold cavity (34) before the isocyanate component and the resin composition are applied or sprayed into the mold cavity (34) and/or cured. The urethane composition may also be applied over the mold release agent and/or coating composition (26) if present and, in the absence thereof, directly into the mold cavity (34). In this situation, the isocyanate component and the resin composition would be applied to the second layer (24) and subsequently cured. It is contemplated that the urethane composition may be sprayed or poured into the mold cavity (34). Most preferably, the urethane composition is sprayed into the mold cavity (34).

Referring now to the step of curing the urethane composition in the mold cavity (34) to form the composite article (20), the step of curing the urethane composition may include the step of curing at a temperature of from 100 to 200, more preferably of from 130 to 150, and most preferably at 140, ° F. and for a time of from 1 to 10 and more preferably from 2 to 5, minutes. The second layer (24), after curing, may have any thickness. Preferably, the second layer (24) has a thickness of from 0.02 to 0.5, and more preferably of from 0.02 to 0.1, inches. The method also includes the step of de-molding the composite article (20) from the mold cavity (34).

The composite article (20) includes the first layer (22) having the specific gravity of from 0.9 to 1.15 g/ml and includes a cured reaction product (i.e., the cured elastomeric urethane composition) of the isocyanate component and the resin composition including the polytetrahydrofuran. The composite article (20) also includes the second layer (24) disposed on the first layer (22) wherein the second layer (24) is formed from the cured urethane composition different from the cured reaction product. The elastomeric urethane composition is preferably used to form composite article (20) including non-automotive parts such as those used in farming, outdoor sport, and marine applications. In a preferred embodiment of the present invention, the elastomeric urethane composition is used to form an outermost layer of a seat body for a farming application.

### EXAMPLES

A series of elastomeric urethane compositions, (Examples 1 through 6) are formed according to the method of the present invention. The Examples 1 through 6 are formed via spraying an isocyanate component and a resin composition into a mold cavity (34) of a mold (32). Specifically, in Examples 1 through 3, the isocyanate component and the resin composition are sprayed into the mold cavity (34) in a substantially planar spray pattern with a fan nozzle (30) of a spray gun (36). In Examples 4 through 6, the isocyanate component and the resin composition are sprayed into the mold cavity (34) in a conical spray pattern with a cone nozzle (28) of the spray gun (36).

After spraying, the isocyanate component and the resin composition are then reacted to form the Examples 1 through 6. After formation, the Examples 1 through 6 are cured at room temperature for 48 hours to form corresponding first layers (22) (Layers 1 through 6). The Layers 1 through 6 are then evaluated for Puncture Resistance and Shore A Durometer Hardness, described in greater detail below.

One comparative elastomeric urethane composition, Comparative Example 1, is also formed, but does not utilize polytetrahydrofuran. Therefore, the Comparative Example 1 serves as a control. Specifically, the Comparative Example 1 is formed via hand-mixing and pouring the isocyanate component and a comparative resin composition into the mold cavity (34). The isocyanate component and the comparative resin composition are reacted to form the Comparative Example 1. Specifically, the comparative resin composition does not include polytetrahydrofuran and instead utilizes a different polyetherol, Polyetherol 1. After formation, the Comparative Example 1 is also cured at room temperature for 48 hours to form a corresponding comparative first layer (Comparative Layer 1). The Comparative Layer 1 is then also evaluated for Puncture Resistance and Shore A Durometer Hardness, also described in greater detail below.

The resin composition used to form the Example 1 through 6 includes Polytetrahydrofuran, two Polymerization Catalysts, First and Second Chain Extenders, the Chain Terminator, the Anti-Foaming Agent, the Molecular Sieve, and the Fumed Silica, as set forth below in Table 1. The comparative resin composition used to form the Comparative Example 1 includes Polyetherol 1, the Two Polymerization Catalysts, the First and Second Chain Extenders, the Chain Terminator, the Anti-Foaming Agent, the Molecular Sieve, and the Fumed Silica, as also set forth below in Table 1. All amounts in Table 1 are parts by weight based on the total weight of the resin composition including the Polytetrahydrofuran for the Examples 1 through 6 or including the Polyetherol 1 for the Comparative Example 1, unless otherwise noted.

After the Examples 1 through 6 and the Comparative Example 1 cure for 48 hours at room temperature to form the Layers 1 through 6 and the Comparative Layer 1, respectively, samples of each of the Layers 1 through 6 and the Comparative Layer 1 are evaluated using a puncture resistance test to determine puncture resistance and ASTM D-2240 to determine the Shore A Durometer Hardness, as set forth in Table 1. The puncture resistance test, as described above, is used to determine the puncture resistance of samples of the Layers 1 through 6 and the Comparative Layer 1 by measuring a force required to cause a 0.1 inch diameter tip of a sharp-edged puncture probe to penetrate the samples of the Layers 1 through 6 and the Comparative Layer 1. ASTM D-2240 (i.e., the Shore A Durometer Hardness test) is used to determine a resistance of the Layers 1 through 6 and the Comparative Layer 1 towards indentation. The data set forth in Table 1 includes results of the puncture resistance test and of ASTM D-2240 to determine the Shore A Durometer Hardness.

TABLE 1

| | | Comparative | | |
|---|---|---|---|---|
| | Component | Example 1 | Example 1 | Example 2 |
| Resin | Polytetrahydrofuran | 0 | 86.23 | 86.23 |
| Composition | Polyetherol 1 | 90 | 0 | 0 |
| | First Chain Extender | 6.5 | 6.52 | 6.52 |
| | Second Chain | 3.5 | 3.28 | 3.28 |
| | Extender | | | |
| | Chain Terminator | 1 | 1 | 1 |
| | Anti-Foaming Agent | 0.1 | 0.1 | 0.1 |
| | Molecular Sieve | 1 | 1.05 | 1.05 |
| | Fumed Silica | 0.6 | 0.5 | 0.5 |
| | Polymerization | 0.3 | 0.33 | 0.33 |
| | Catalyst 1 | | | |
| | Polymerization | 1 | 1 | 1 |
| | Catalyst 2 | | | |
| | Total | 104 | 100 | 100 |
| Isocyanate | Isocyanate | 51.36 | 74.54 | 76.06 |
| Component | Component, amount | | | |
| | by weight based on | | | |
| | 100 parts of the | | | |
| | Resin Composition | | | |
| | Isocyanate Index | 102.5 | 98 | 100 |
| | Weight Ratio | 51.36 | 74.5 | 76 |
| | % NCO | 23 | 23 | 23 |
| | Thickness (in.) | 0.05 | 0.05 | 0.05 |
| | Type of Spray | None/ | Fan | Fan |
| | Nozzle | Hand Mix | | |
| | Specific Gravity | 1.08 | 0.96 | 0.96 |
| | (g/ml) | | | |
| | Puncture Resistance | 357 | 476 | 466 |
| | (ppi) | | | |
| | Shore A Durometer | 70 | 71 | 71 |
| | Hardness | | | |

| | Component | Example 3 | Example 4 | Example 5 |
|---|---|---|---|---|
| Resin | Polytetrahydrofuran | 86.23 | 86.23 | 86.23 |
| Composition | Polyetherol 1 | 0 | 0 | 0 |
| | First Chain Extender | 6.52 | 6.52 | 6.52 |
| | Second Chain | 3.28 | 3.28 | 3.28 |
| | Extender | | | |
| | Chain Terminator | 1 | 1 | 1 |
| | Anti-Foaming Agent | 0.1 | 0.1 | 0.1 |
| | Molecular Sieve | 1.05 | 1.05 | 1.05 |
| | Fumed Silica | 0.5 | 0.5 | 0.5 |
| | Polymerization | 0.33 | 0.33 | 0.33 |
| | Catalyst 1 | | | |
| | Polymerization | 1 | 1 | 1 |
| | Catalyst 2 | | | |
| | Total | 100 | 100 | 100 |
| Isocyanate | Isocyanate | 77.58 | 74.54 | 76.06 |
| Component | Component, amount | | | |
| | by weight based on | | | |
| | 100 parts of the | | | |
| | Resin Composition | | | |
| | Isocyanate Index | 102 | 98 | 100 |
| | Weight Ratio | 77.6 | 74.5 | 76 |
| | % NCO | 23 | 23 | 23 |
| | Thickness (in.) | 0.05 | 0.05 | 0.05 |
| | Type of Spray | Fan | Cone | Cone |
| | Nozzle | | | |
| | Specific Gravity | 0.96 | 1.10 | 1.10 |
| | (g/ml) | | | |
| | Puncture Resistance | 536 | 663 | 707 |
| | (ppi) | | | |
| | Shore A Durometer | 72 | 71 | 72 |
| | Hardness | | | |

| | Component | Example 6 |
|---|---|---|
| Resin | Polytetrahydrofuran | 86.23 |
| Composition | Polyetherol 1 | 0 |
| | First Chain Extender | 6.52 |
| | Second Chain | 3.28 |
| | Extender | |
| | Chain Terminator | 1 |
| | Anti-Foaming Agent | 0.1 |
| | Molecular Sieve | 1.05 |
| | Fumed Silica | 0.5 |
| | Polymerization | 0.33 |
| | Catalyst 1 | |
| | Polymerization | 1 |
| | Catalyst 2 | |
| | Total | 100 |
| Isocyanate | Isocyanate | 77.58 |
| Component | Component, amount | |
| | by weight based on | |
| | 100 parts of the | |
| | Resin Composition | |
| | Isocyanate Index | 102 |
| | Weight Ratio | 77.6 |
| | % NCO | 23 |
| | Thickness (in.) | 0.05 |
| | Type of Spray | Cone |
| | Nozzle | |
| | Specific Gravity | 1.09 |
| | (g/ml) | |
| | Puncture Resistance | 772 |
| | (ppi) | |
| | Shore A Durometer | 74 |
| | Hardness | |

The Polytetrahydrofuran, commercially available from BASF Corporation of Wyandotte, Mich., under the trade name of PolyTHF® 1000, is a di-functional, linear, saturated polyether polyol that has a hydroxyl number of from 106.9 to 118.1 mg KOH/g and a number average molecular weight of approximately 1000 g/mol. The PolyTHF® 1000 is derived from polymerization of tetrahydrofuran.

The Polyetherol 1, commercially available from BASF Corporation of Wyandotte, Mich., under the trade name of Pluracolo 380, is a primary hydroxyl terminated triol that includes an ethylene oxide cap of 15% by weight based on the total weight of the Polyetherol 1, and has a number average molecular weight of 6500 g/mol, a hydroxyl number of 25 mg KOH/g, and a nominal functionality of 2.29.

The First Chain Extender is 1,4-butanediol and is commercially available from BASF Corporation of Wyandotte, Mich.

The Second Chain Extender is 1,3-butanediol and is commercially available from GE Silicones of Wilton, Conn., under the trade name of NIAXO Processing Additive DP-1022.

The Chain Terminator is a blend of C₁₂, C₁₃, C₁₄ and C₁₅ high purity primary alcohols and is commercially available from Shell Chemicals of Houston, Tex., under the trade name of Neodol® 25.

The Anti-Foaming Agent is a silicone liquid and is commercially available from Dow Corning of Midland, Mich., under the trade name of Antifoam-A.

The Molecular Sieve is commercially available from UOP, LLC, of Des Plaines, Ill., under the trade name of Molecular Sieve Type 3A.

The Fumed Silica is commercially available from Degussa AG of Düsseldorf, Germany, under the trade name of Aerosil® R972.

The Polymerization Catalyst 1 is ethylhexanoic acid blocked 1,8-Diazabicyclo[5.4.0]undec-7-ene commercially available from Air Products and Chemicals, Inc. of Allentown, Pa., under the trade name of Polycath SA-102.

The Polymerization Catalyst 2 is a mixture of triethylenediamine and 1,4 butanediol and is commercially available from Air Products and Chemicals, Inc. of Allentown, Pa., under the trade name of DABCO®S-25.

The Isocyanate Component, commercially available from BASF Corporation of Wyandotte, Mich., under the trade name of Lupranate® MP-102, is a liquid modified pure diphenylmethane diisocyanate that includes a % NCO content of 23%, a nominal functionality of 2, a viscosity of 700 cps at 25° C., a number average equivalent weight of 183 g/eq, and a number average molecular weight of 366 g/mol.

The Isocyanate Index, as first introduced above, is defined as a ratio of the number of isocyanate (NCO) groups in the Isocyanate Component to the number of hydroxyl (OH) groups in the Polytetrahydrofuran for Examples 1 through 6 or the Polyetherol 1 for Comparative Example 1.

The Weight Ratio is the ratio of the parts by weight of the Isocyanate Component reacted to the parts by weight of the Polytetrahydrofuran reacted for Examples 1 through 6 or the Polyetherol 1 for Comparative Example 1.

The % NCO is the percent by weight of the NCO groups of the Isocyanate Component. Determination of the % NCO content on percent by weight is accomplished by a standard chemical titration analysis known to those skilled in the art.

The results of the determinations of puncture resistance indicate that the Layers 1 through 6, corresponding to the Examples 1 through 6 formed from the method of the present invention, exhibit excellent puncture resistance thereby eliminating a need to continually increase thickness of the first layer (22) to increase puncture resistance. The determinations of the puncture resistance of the Layers 1 through 6 suggest that each of the Layers 1 through 6 is suitable for use as an outermost layer in non-automotive seat applications. The results of the determinations of Shore A Durometer Hardness indicate that the Layers 1 through 6, corresponding to the Examples 1 through 6 formed from the method of the present invention, exhibit sufficient Shore A Durometer Hardness such that each of the Layers 1 through 6 is suitable for use as an outermost layer in non-automotive seat applications.

Obviously, many modifications and variations of the present invention are possible in light of the above teachings. The invention may be practiced otherwise than as specifically described within the scope of the appended claims.

What is claimed is:

1. A method of forming a composite article in a mold having a mold cavity, said method comprising the steps of:
a) applying an isocyanate component and a resin composition comprising polytetrahydrofuran into the mold cavity;
b) reacting the isocyanate component and the resin composition to form an elastomeric urethane composition;
c) curing the elastomeric urethane composition to form a first layer having a specific gravity of from 0.9 to 1.15 g/ml;
d) applying a urethane composition different from the elastomeric urethane composition into the mold cavity;
e) curing the urethane composition in the mold cavity to form a second layer and to form the composite article; and
f) de-molding the composite article from the mold cavity.

2. A method as set forth in claim 1 wherein the resin composition comprises at least 60 parts by weight of polytetrahydrofuran per 100 parts by weight of the resin composition.

3. A method as set forth in claim 2 wherein the resin composition is substantially free of polyols other than polytetrahydrofuran.

4. A method as set forth in claim 1 wherein the step of applying the isocyanate component and the resin composition into the mold cavity comprises the step of spraying at least one of the isocyanate component and the resin composition into the mold cavity in one of a conical spray pattern or a substantially planar spray pattern.

5. A method as set forth in claim 1 wherein the step of spraying at least one of the isocyanate component and the resin composition into the mold cavity comprises the step of spraying at least one of the isocyanate component and the resin composition into the mold cavity in a conical spray pattern.

6. A method as set forth in claim 1 wherein the step of spraying at least one of the isocyanate component and the resin composition into the mold cavity comprises the step of spraying at least one of the isocyanate component and the resin composition into the mold cavity in a substantially planar spray pattern.

7. A method as set forth in claim 1 wherein the resin composition further comprises a polymerization catalyst present in the resin composition in an amount of from 0.02 to 1.5 parts by weight per 100 parts by weight of the resin composition.

8. A method as set forth in claim 7 wherein the resin composition further comprises an additive selected from the group of chain extenders, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, thixotropic agents, and combinations thereof.

9. A method as set forth in claim 1 wherein the isocyanate component comprises an aromatic isocyanate.

10. A method as set forth in claim 1 wherein the step of reacting the isocyanate component and the resin composition comprises the step of reacting the isocyanate component and the resin composition at an isocyanate index of from 95 to 105.

11. A method as set forth in claim 1 wherein the resin composition further comprises a polyol different from the polytetrahydrofuran.

12. A method as set forth in claim 1 wherein the step of curing the elastomeric urethane composition to form the first layer comprises the step of curing the elastomeric urethane composition to form the first layer at a temperature of from 60 to 80° F.

13. A method as set forth in claim 1 wherein the step of curing the urethane composition in the mold cavity comprises the step of curing the urethane composition in the mold cavity at a temperature of from 130 to 150° F. and for a time of from 2 to 5 minutes.

14. A method as set forth in claim 1 wherein the urethane composition comprises a foamed urethane composition.

15. A method as set forth in claim 1 wherein the first layer has a thickness of from 0.025 to 0.15 inches.

16. A method as set forth in claim 1 wherein the resin composition consists essentially of polytetrahydrofuran.

17. A method as set forth in claim 1 wherein the resin composition is substantially free of polyols other than polytetrahydrofuran and comprises at least 60 parts by weight of polytetrahydrofuran per 100 parts by weight of the resin composition, and the step of applying the isocyanate component and the resin composition into the mold cavity comprises the step of spraying at least one of the isocyanate component and the resin composition into the mold cavity in one of a conical spray pattern or a substantially planar spray pattern with one of a cone nozzle or a fan nozzle respectively.

18. A method as set forth in claim 17 wherein:
a) the resin composition further comprises;
(1) a polymerization catalyst present in the resin composition in an amount of from 0.02 to 1.5 parts by weight per 100 parts by weight of the resin composition, and
(2) an additive selected from the group of chain extenders, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, thixotropic agents, and combinations thereof, and
b) the isocyanate component comprises an aromatic isocyanate; and the step of reacting the isocyanate component and the resin composition comprises the step of reacting the isocyanate component and the resin composition at an isocyanate index of from 95 to 105, the step of curing the elastomeric urethane composition to form the first layer comprises the step of curing the elastomeric urethane composition to form the first layer at a temperature of from 60 to 80° F., the step of curing the urethane composition in the mold cavity comprises the step of curing the urethane composition in the mold cavity at a temperature of from 130 to 150° F. and for a time of from 2 to 5 minutes, the urethane composition comprises a foamed urethane composition, and the first layer has a thickness of from 0.025 to 0.15 inches.

19. A composite article comprising:
a) a first layer having a specific gravity of from 0.9 to 1.15 g/ml and comprising a cured reaction product of an isocyanate component and a resin composition comprising polytetrahydrofuran; and
b) a second layer disposed on said first layer and comprising a cured urethane composition different from said cured reaction product.

20. A composite article as set forth in claim 19 wherein said resin composition comprises at least 60 parts by weight of polytetrahydrofuran per 100 parts by weight of said resin composition.

21. A composite article as set forth in claim 20 wherein said resin composition is substantially free of polyols other than polytetrahydrofuran.

22. A composite article as set forth in claim 19 wherein said resin composition further comprises a polymerization catalyst present in said resin composition in an amount of from 0.02 to 1.5 parts by weight per 100 parts by weight of said resin composition.

23. A composite article as set forth in claim 19 wherein said isocyanate component comprises an aromatic isocyanate.

24. A composite article as set forth in claim 19 wherein said resin composition and said isocyanate component are reacted at an isocyanate index of from 95 to 105.

25. A composite article as set forth in claim 19 wherein said resin composition further comprises a polyol different from said polytetrahydrofuran.

26. A composite article as set forth in claim 19 wherein said urethane composition comprises a foamed urethane composition.

27. A composite article as set forth in claim 19 wherein said first layer has a thickness of from 0.025 to 0.15 inches.

28. A composite article as set forth in claim 19 wherein said resin composition consists essentially of polytetrahydrofuran.

29. A composite article as set forth in claim 19 wherein said first layer is further defined as a show surface of said composite article.

30. A composite article as set forth in claim 19 wherein said resin composition is substantially free of polyols other than polytetrahydrofuran, said resin composition comprises at least 60 parts by weight of polytetrahydrofuran per 100 parts by weight of said resin composition, said resin composition further comprises a polymerization catalyst comprising an amine and present in said resin composition in an amount of from 0.02 to 1.5 parts by weight per 100 parts by weight of said resin composition, and said isocyanate component comprises a 4,4′-methylene diphenyldiisocyanate and is reacted with said resin composition at an isocyanate index of from 95 to 105.

31. A method of forming a composite article in a mold having a mold cavity, said method comprising the steps of:
a) spraying an isocyanate component and a resin composition comprising polytetrahydrofuran into the mold cavity in one of a conical spray pattern or a substantially planar spray pattern;
b) reacting the isocyanate component and the resin composition to form an elastomeric urethane composition;
c) curing the elastomeric urethane composition to form a first layer;
d) applying a urethane composition different from the elastomeric urethane composition into the mold cavity;
e) curing the urethane composition in the mold cavity to form a second layer and to form the composite article; and
f) de-molding the composite article from the mold cavity.

32. A method as set forth in claim 31 wherein the first layer has a specific gravity of from 0.9 to 1.15 g/ml.

33. A method as set forth in claim 31 wherein the resin composition comprises at least 60 parts by weight of polytetrahydrofuran per 100 parts by weight of the resin composition.

34. A method as set forth in claim 33 wherein the resin composition is substantially free of polyols other than polytetrahydrofuran.

35. A method as set forth in claim 31 wherein the step of spraying the isocyanate component and the resin composition into the mold cavity comprises the step of spraying at least one of the isocyanate component and the resin composition into the mold cavity in the conical spray pattern.

36. A method as set forth in claim 31 wherein the step of spraying the isocyanate component and the resin composition into the mold cavity comprises the step of spraying at least one of the isocyanate component and the resin composition into the mold cavity in the substantially planar spray pattern.

37. A method as set forth in claim 31 wherein the step of spraying the isocyanate component and the resin composition in one of the conical spray pattern or the substantially planar spray pattern comprises the step of spraying at least one of the isocyanate component and the resin composition into the mold cavity with one of a cone nozzle or a fan nozzle respectively.

38. A method as set forth in claim 31 wherein the resin composition further comprises a polymerization catalyst present in the resin composition in an amount of from 0.02 to 1.5 parts by weight per 100 parts by weight of the resin composition.

39. A method as set forth in claim 31 wherein the isocyanate component comprises an aromatic isocyanate.

40. A method as set forth in claim 31 wherein the step of reacting the isocyanate component and the resin composition comprises the step of reacting the isocyanate component and the resin composition at an isocyanate index of from 95 to 105.

41. A method as set forth in claim 31 wherein the resin composition further comprises a polyol different from the polytetrahydrofuran.

42. A method as set forth in claim 31 wherein the step of curing the elastomeric urethane composition to form the first layer comprises the step of curing the elastomeric urethane composition to form the first layer at a temperature of from 60 to 80° F.

43. A method as set forth in claim 31 wherein the step of curing the urethane composition in the mold cavity comprises the step of curing the urethane composition in the mold cavity at a temperature of from 130 to 150° F. and for a time of from 2 to 5 minutes.

44. A method as set forth in claim 31 wherein the urethane composition comprises a foamed urethane composition.

45. A method as set forth in claim 31 wherein the first layer has a thickness of from 0.025 to 0.15 inches and is further defined as a show surface of the composite article.

46. A method as set forth in claim 31 wherein the resin composition consists essentially of polytetrahydrofuran.

47. A method as set forth in claim 31 wherein the first layer has a specific gravity of from 0.9 to 1.15 g/ml, the resin composition comprises at least 60 parts by weight of polytetrahydrofuran per 100 parts by weight of the resin composition, and the step of spraying the isocyanate component and the resin composition into the mold cavity in one of the conical spray pattern or the substantially planar spray pattern comprises the step of spraying at least one of the isocyanate component and the resin composition with one of a cone nozzle or a fan nozzle respectively.

48. A method as set forth in claim 47 wherein:
a) the resin composition further comprises a polymerization catalyst present in the resin composition in an amount of from 0.02 to 1.5 parts by weight per 100 parts by weight of the resin composition, and
b) the isocyanate component comprises an aromatic isocyanate, and the step of reacting the isocyanate component and the resin composition comprises the step of reacting the isocyanate component and the resin composition at an isocyanate index of from 95 to 105, the step of curing the elastomeric urethane composition to form the first layer comprises the step of curing the elastomeric urethane composition to form the first layer at a temperature of from 60 to 80° F., the step of curing the urethane composition in the mold cavity comprises the step of curing the urethane composition in the mold cavity at a temperature of from 130 to 15 0° F. and for a time of from 2 to 5 minutes, the urethane composition comprises a foamed urethane composition, and the first layer has a thickness of from 0.025 to 0. 15 inches.
